(19) United States
(12) Patent Application Publication
(10) Pub. No.: US 2026/0166681 A1
(43) Pub. Date: Jun. 18, 2026

(54) ROBOT-AIDED CLAMPING DEVICE

(71) Applicant: ABB SCHWEIZ AG, Baden (CH)

(72) Inventors: Haoteng Lei, Shanghai (CN); Dilong Yu, Shanghai (CN); Dongjie Guo, Shanghai (CN); Yin Tian, Shanghai (CN)

(21) Appl. No.: 19/536,778

(22) Filed: Feb. 11, 2026

Related U.S. Application Data
(63) Continuation of application No. PCT/CN2023/112572, filed on Aug. 11, 2023.

(51) Int. Cl. B25B 5/06; B25J 9/16

(52) U.S. Cl. CPC B25B 5/061; B25J 9/1633; B25J 9/1674; B25J 9/1694; B25J 9/1697

(57) ABSTRACT

Embodiments of the present disclosure relate to a robot-aided clamping device for pick-and-placing a storage box, including a frame configured to be mounted on an end effector of a robot; and a plurality of clamping units including: at least one first clamping unit mounted on a first side of the frame and configured to clamp a first side wall of the storage box; and at least one second clamping unit mounted on a second side of the frame and configured to clamp a second side wall of the storage box. The first side and the second side are non-opposite sides of the frame, and the first side wall and the second side wall are non-opposite side walls of the storage box.

### FIELD OF THE INVENTION

This invention relates to the stacking or unstacking technique, and in particular, to a robot-aided clamping device.

### BACKGROUND OF THE INVENTION

The robot-aided devices are increasingly popular to be used in various industries. Just as an example, a robot-aided stacking or unstacking machine (also referred to as a palletizing robot) may be used to stack or unstack various storage boxes (also referred to as logistic boxes or tote boxes), which may greatly save labour and make stacking or unstacking operations more flexible, accurate and stable.

In order to adapt to different working scenarios, a palletizing robot generally has a designed clamping fixture tailored to the actual working scenario, which clamping fixture may be e.g., a splint fixture, a claw fixture, or a vacuum sucking fixture.

### SUMMARY OF THE INVENTION

The invention is defined by the claims.

According to one aspect of the disclosure, there is provided a robot-aided clamping device for pick-and-placing a storage box, comprising: a frame configured to be mounted on an end effector of a robot; and a plurality of clamping units including: at least one first clamping unit mounted on a first side of the frame and configured to clamp a first side wall of the storage box; and at least one second clamping unit mounted on a second side of the frame and configured to clamp a second side wall of the storage box; wherein the first side and the second side are non-opposite sides of the frame, and the first side wall and the second side wall are non-opposite side walls of the storage box.

In some embodiments, the first side and the second side are asymmetrical or adjacent sides of the frame, and the first side wall and the second side wall are asymmetrical or adjacent side walls of the storage box.

In some embodiments, each of the plurality of clamping units comprises: an actuator; and at least two clamping jaws configured to be actuated by the actuator to clamp the respective side wall of the storage box.

In some embodiments, the at least two clamping jaws comprise: at least one inner jaw configured to abut against the inner surface of the respective side wall; and at least one outer jaw configured to abut against the outer surface of the respective side wall, such that the respective side wall is clamped between the at least one inner jaw and the at least one outer jaw.

In some embodiments, the storage box has at least one protrusion rib or recess on its outer surface, the at least one outer jaw has a hook part configured to engage with the at least one protrusion rib.

In some embodiments, the first side is a long side of the frame as compared to the second side, and the first side wall is a long side wall of the storage box as compared to the second side wall; wherein the at least one first clamping unit comprises two first clamping units mounted on the first side of the frame, and the at least one second clamping unit comprises only one second clamping unit mounted on the second side of the frame.

In some embodiments, the at least one first clamping unit and the at least one second clamping unit each are configured to be movable along the respective side of the frame.

In some embodiments, the robot-aided clamping device further comprises: a balancing mechanism arranged on a joint portion between the first side and the second side of the frame, and configured to abut against a joint part between the first side wall and the second side wall of the storage box.

In some embodiments, the clamping unit is selected from a group consisted of a pneumatic clamping unit, a hydraulic clamping unit and an electric clamping unit.

In some embodiments, the pneumatic clamping unit comprises a pneumatic actuator and at least two clamping jaws comprising two parallel jaws configured to be moved in parallel with each other, or two angular jaws configured to be moved in an angular manner with respect to each other.

In some embodiments, the robot-aided clamping device further comprises an image acquiring device configured to obtain the image of the storage box and/or at least one of the plurality of clamping units.

In some embodiments, the robot-aided clamping device further comprises a controller configured to control the actuation of the plurality of clamping units and/or determine the position of at least one of the plurality of clamping units.

In some embodiments, the frame has a shape or a size corresponding to that of the storage box.

In some embodiments, the frame and the storage box both have a rectangular shape.

According to another aspect of the disclosure, there is provided a robot system comprising: a robot having an end effector; and the above mentioned robot-aided clamping device mounted on the end effector.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1 illustrates a schematic diagram of a robot-aided clamping device for pick-and-placing a storage box according to one embodiment of the present disclosure;

FIG. 2 illustrates an enlarged view of the robot-aided clamping device for pick-and-placing the storage box according to one embodiment of the present disclosure;

FIG. 3A illustrates a perspective view of the robot-aided clamping device when picking up the storage box according to one embodiment of the present disclosure;

FIG. 3B illustrates a side view of the robot-aided clamping device when picking up the storage box according to one embodiment of the present disclosure;

FIG. 3C illustrates another side view of the robot-aided clamping device when picking up the storage box according to one embodiment of the present disclosure;

FIGS. 4A and 4B illustrate two different stacking conditions of the storage box;

FIG. 5A illustrates a perspective view of an exemplary clamping unit according to one embodiment of the present disclosure; and

FIG. 5B illustrates a side view of the exemplary clamping unit according to one embodiment of the present disclosure.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

As mentioned above, a palletizing robot may be used to stack or unstack the storage boxes and the clamping fixture is generally tailored to the actual working scenario. However, it is found that the conventional clamping fixtures used by the robot generally have a symmetrical clamping structure, which implies that it cannot be adapted to various stacking or unstacking conditions, resulting in limited adaptability or poor flexibility, which may in turn affect the working ability, quality, efficiency and cost of the palletizing robot.

In order to overcome the above disadvantages of the conventional clamping fixtures, the present disclosure provides an improved robot-aided clamping device for pick-and-placing a storage box, which comprises a frame configured to be mounted on an end effector of a robot; and a plurality of clamping units. The plurality of clamping units includes at least one first clamping unit mounted on a first side of the frame and configured to clamp a first side wall of the storage box, and at least one second clamping unit mounted on a second side of the frame and configured to clamp a second side wall of the storage box, wherein the first side and the second side are non-opposite sides of the frame, and the first side wall and the second side wall are non-opposite side walls of the storage box. With the above arrangement of the clamping units, those skilled in the art would appreciate that the robot-aided clamping device of the present disclosure may then pick-and-place a storage box even in an asymmetrical manner, which will improve the adaptability or flexibility of robot-aided clamping device.

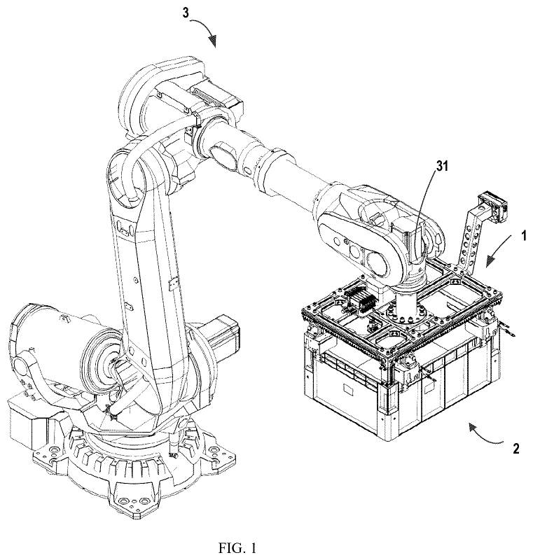

For better understanding of the concept of the present disclosure, FIG. 1 illustrates a schematic diagram of a robot-aided clamping device for pick-and-placing a storage box according to one embodiment of the present disclosure.

As shown in FIG. 1, a robot-aided clamping device 1 for pick-and-placing a storage box 2 may be mounted on an end effector 31 of a robot 3. Generally, the robot 3 may be an industrial robot. As an example, the robot may be one having multiple arms with multiple degrees of freedom, e.g., a two-arm robot with 6 degrees of freedom. In some embodiments, a controller or processor may be associated with or integrated with the robot 3, such that the end effector 31 as well as the robot-aided clamping device 1 being held or mounted thereon may be guided to a desired position or moved along a planned path.

The storage box 2 are durable and reusable containers which comprise an inner space such that items or objects may be housed therein. They're available in a variety of sizes to hold an assortment of objects, so they provide a great way to save space and keep areas tidy and organised. In the logistics field, the storage box 2 may be referred to as a logistic box or a tote box, which is generally designed so that it may be stacked on top of each other, and then be moved from place to place.

Typically, the storage box 2 may have a rectangular shape with four side walls and an inner space surrounding by the four side walls. The inner space may be used to house an assortment of objects. Those skilled in the art would appreciate that other shapes of the storage box 2 are also possible. Further, the storage box 2 may comprise an opening defined by the opening-side edges of four side walls and from which opening an assortment of objects may be put into the storage box 2.

Typically, the storage box 2 may be made of plastic, which may reduce the cost of the storage box. Those skilled in the art would appreciate that other materials for manufacturing the storage box are also possible.

In some embodiments, the storage box 2 may further have at least one protrusion rib 210 or recess on its outer surface or inner surface, especially near the opening-side edges of the side walls. The at least one protrusion rib 210 may be used as a strengthen rib, which may aid to strengthen the structure of the storage box.

In the present disclosure, the robot-aided clamping device 1 are designed to pick-and-place a storage box 2 via the clamping of the side walls of the storage box 2. In some embodiments, the robot-aided clamping device 1 may be particularly designed to pick-and-place a storage box 2 via the clamping of the opening-side edges of side walls of the storage box 2.

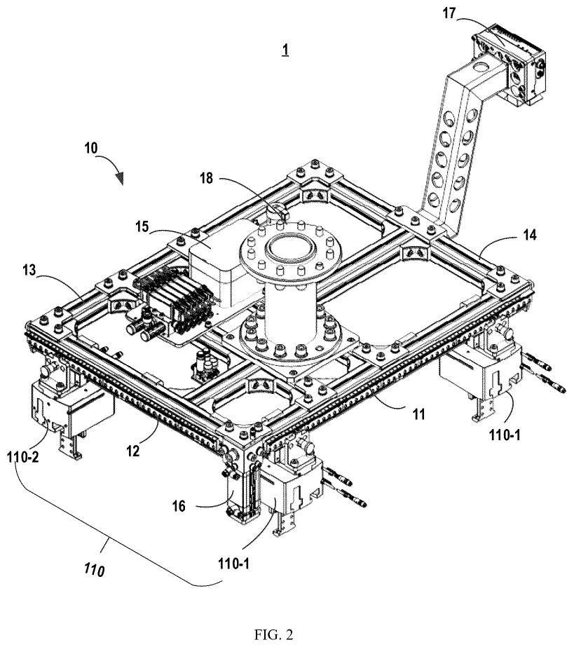

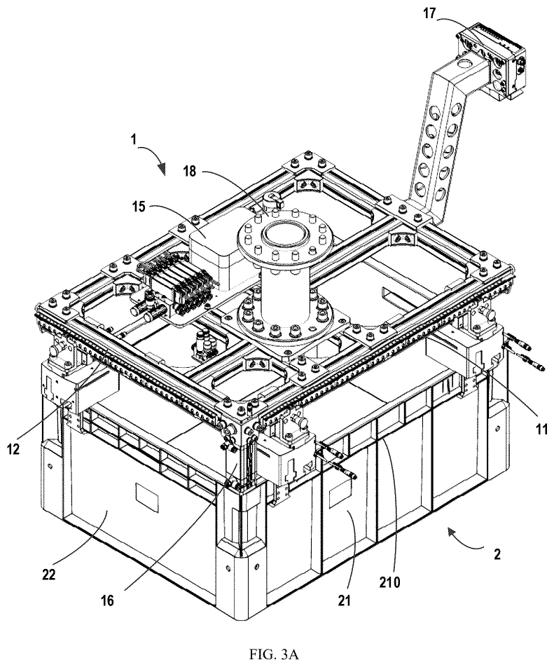

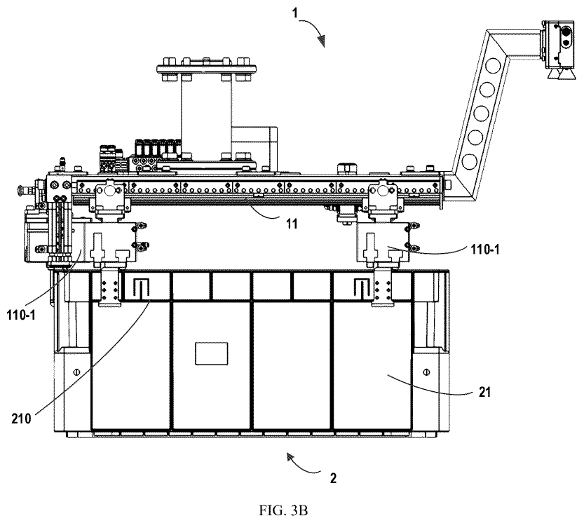

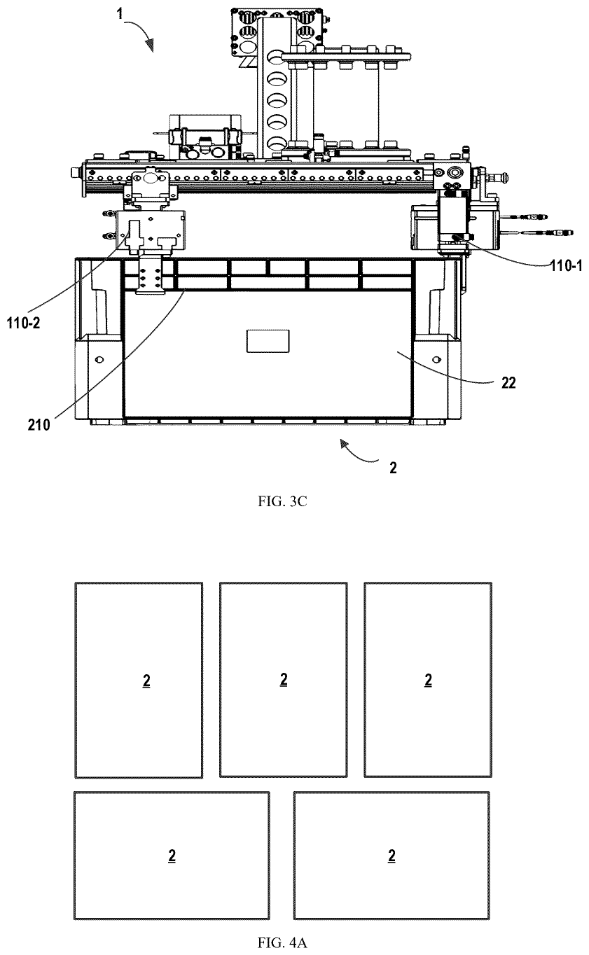

FIG. 2 illustrates an enlarged view of the robot-aided clamping device for pick-and-placing the storage box according to one embodiment of the present disclosure; FIG. 3A illustrates a perspective view of the robot-aided clamping device when picking up the storage box according to one embodiment of the present disclosure; FIG. 3B illustrates a side view of the robot-aided clamping device when picking up the storage box according to one embodiment of the present disclosure; and FIG. 3C illustrates another side view of the robot-aided clamping device when picking up the storage box according to one embodiment of the present disclosure.

As shown in FIGS. 2-3C, the robot-aided clamping device 1 may comprise a frame 10 and a plurality of clamping units 110 configured to clamp the side walls of the storage box 2, especially the opening-side edges of the side walls of the storage box 2.

The frame 10 may be configured in any appropriate shape. Typically, the frame may have a shape or a size corresponding to that of the storage box. In some embodiments where the storage box 2 has a rectangular shape, the frame 10 may also have a rectangular shape or a size corresponding to that of the storage box.

In accordance with the present disclosure, the frame 10 may be provided with an interface connector 18 with which the end effector 31 of the robot 3 may be coupled. Just as an example, the interface connector 18 may include a flange fixed on the frame 10, and the end effector 31 may then be connected to the frame 10 via the flange.

The plurality of clamping units 110 may be mounted on the sides of the frame 10. In some embodiments, the plurality of clamping units 110 may be fixedly mounted on the sides of the frame 10. In some embodiments, the plurality of clamping units 110 may be movably mounted on the sides of the frame 10, which may facilitate the adjustment of the position of the plurality of clamping units 110.

In some embodiments, the frame 10 comprises a first side 11 and a second side 12, which may be non-opposite sides. The non-opposite sides may include adjacent sides or asymmetrical sides. In embodiments where the frame 10 has a rectangular shape, the frame may comprise a first side 11, a second side 12, a third side 13 and a fourth side 14, wherein the first side 11 and the third side 13 are opposite sides, and the second side 13 and the fourth side 14 are opposite sides.

In some embodiments, as shown in FIGS. 3A-3C, the plurality of clamping units 110 may comprise at least one first clamping unit 110-1 and at least one second clamping unit 110-2. The at least one first clamping unit 110-1 may be mounted on a first side 11 of the frame 10 and configured to clamp a first side wall 21 of the storage box 2, especially the first opening-side edge of the first side wall 21. The at least one second clamping unit 110-2 may be mounted on a second side 12 of the frame 10 and configured to clamp a second side wall 22 of the storage box 2, especially the second opening-side edge of the second side wall 22. The number of the at least one first clamping unit 110-1 and the number of the at least one second clamping unit 110-2 may be selected as desired, which may depend on the length of the first side wall 21 and the second side wall 22 of the storage box 2.

Just as an example, in embodiments where the storage box 2 has a rectangular shape, the first side wall 21 may be the long side wall of the storage box 2 and which may be equipped with two first clamping units 110-1, while the second side wall 22 may be the short side wall of the storage box 2 and which may be equipped with merely one second clamping unit 110-2.

Those skilled in the art would appreciate that with the above arrangement of the first and second clamping units, the non-opposite side walls of the storage box may be clamped by the clamping units, and then the storage box may be pick-and-placed. Due to the fact that the first and second clamping units are configured to be able to clamp the non-opposite side walls of the storage box, it will aid the robot-aided clamping device of the present disclosure to adapt to the various working conditions.

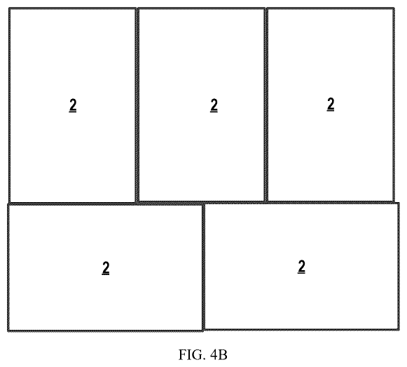

Just as examples, FIGS. 4A and 4B illustrate two different stacking conditions of the storage box 2. As shown in FIGS. 4A and 4B, the storage box 2 are stacked seamlessly in FIG. 4B as compared to the stacking condition in FIG. 4A. In such a seamless stacking condition in FIG. 4B, those skilled in the art would appreciate that it is difficult for the conventional clamping device to pick-and-place the storage box, this is simply because there are no symmetrical positions for the conventional clamping device to grip or clamp. However, unlike the conventional clamping device, since the robot-aided clamping device of the present disclosure is configured to be able to clamp the non-opposite side walls of the storage box, it would be easy for the robot-aided clamping device of the present disclosure to find appropriate non-opposite side walls to clamp even in the case of the seamless stacking condition as shown in FIG. 4B.

Although the present disclosure aims at clamping the non-opposite side walls of the storage box, in some embodiments it is also possible that the robot-aided clamping device of the present disclosure may be configured to clamp the symmetrical side walls or opposite side walls of the storage box. For this purpose, in some embodiments additional clamping units may for example be mounted on other sides (e.g., a third side 13 and/or a fourth side 14) of the frame 10 and configured to clamp other corresponding side walls of the storage box 2. With this arrangement, those skilled in the art would appreciate that it may further improve the adaptability or flexibility of the robot-aided clamping device of the present disclosure, as the clamping units may be more freely selected to best suit the specific stacking condition of the storage box.

In accordance with the present disclosure, the type of the clamping unit is not limited, as long as it may be used to clamp the side wall of the storage box, especially the opening-side edge of the side wall. In some embodiments, the actuator may be selected from a group consisted of a pneumatic clamping unit, a hydraulic clamping unit and an electric clamping unit.

Typically, each of the plurality of clamping units 110 may comprise an actuator, and at least two clamping jaws 120 configured to be actuated by the actuator to clamp the respective side wall of the storage box 2. In some embodiments, the at least two clamping jaws 120 may comprise at least one inner jaw 120-1 and at least one outer jaw 120-2. The at least one inner jaw 120-1 may be configured to abut against the inner surface of the respective side wall, while the at least one outer jaw 120-2 may be configured to abut against the outer surface of the respective side wall, such that the respective side wall is clamped between the at least one inner jaw 120-1 and the at least one outer jaw 120-2.

Just as an example, in the case of a pneumatic clamping unit, the pneumatic clamping unit may comprise a pneumatic cylinder as an actuator and the at least two clamping jaws 120 may comprise two parallel jaws configured to be moved in parallel with each other, or two angular jaws configured to be moved in an angular manner with respect to each other.

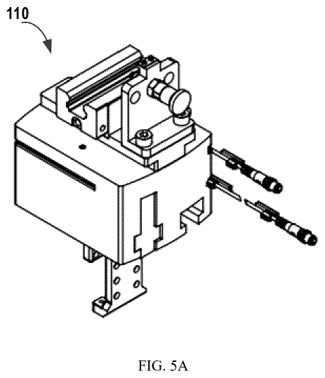

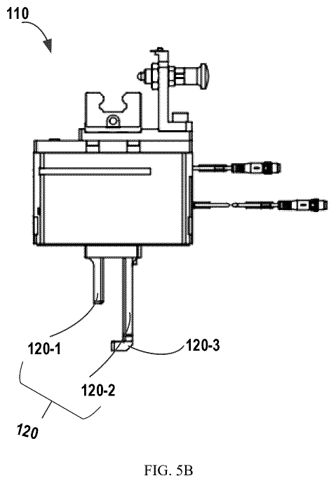

For better understanding of the clamping unit 110, FIG. 5A illustrates a perspective view of an exemplary clamping unit according to one embodiment of the present disclosure, and FIG. 5B illustrates a side view of the exemplary clamping unit according to one embodiment of the present disclosure.

As shown in FIGS. 5A and 5B, the exemplary clamping unit 110 may be a pneumatic clamping unit, which may comprise a pneumatic cylinder (not shown in FIGS. 5A and 5B) as an actuator and two parallel jaws 120 configured to be moved in parallel with each other, e.g., being moved towards or away from each other in parallel. The two parallel jaws 120 may comprise an inner jaw 120-1 and an outer jaw 120-2, wherein the inner jaw 120-1 may be configured to abut the inner surface of the respective side wall of the storage box 2, and the outer jaw 120-2 may be configured to abut the outer surface of the respective side wall of the storage box 2, such that the respective side wall may be clamped between the inner jaw 120-1 and the outer jaw 120-2. In some embodiments, in order to clamp the side wall of the storage box tightly or robustly, at least one of the inner jaw 120-1 and the outer jaw 120-2 may further comprise a hook part 120-3, which may be configured to engage with the at least one protrusion rib 210 or recess arranged on the inner surface or the outer surface of the storage box. For example, as shown in FIGS. 5A and 5B, the outer jaw 120-2 may comprise a hook part 120-3, which may be used to engage with the at least one protrusion rib 210 arranged on the outer face of the storage box 2.

In order to facilitate the clamping of the side walls of the storage box 2 at a proper position, it is advantageous to provide a movable clamping unit 110 along the respective side of the frame 10. In order for this, in some embodiments a track may be arranged on the respective side of the frame 10 and then the clamping unit 110 may be movably mounted on the track. Further, in some embodiments a graduated scale may be provided on the respective side of the frame 10, which may further facilitate the positioning of the clamping units 110.

In some embodiments, the adjustment of the positions of the clamping units 110 may be automatically controlled by a controller 15. Just as an example, the controller 15 may be arranged on the frame 10, the robot 1 or at a position away from the frame 10 or the robot 3. In some embodiments, the controller 15 for controlling the clamping units and the controller for the robot 1 may be the same controller.

In order to facilitate the automatic adjustment of the positions of the clamping units 110, in some embodiments an image acquiring device 17 may be provided, which may be configured to obtain the image of the storage box 2, the at least one of the plurality of clamping units 110 and/or the surrounding environment. Just as an example, the image acquiring device 17 may be arranged on the frame 10, the robot 1 or at a position away from the frame 10 or the robot 3. Once the image is obtained, the image may be communicated to the controller 15 to determine the position and/or orientation of the storage box 2, and/or the position and/or orientation or the desired clamping unit 110. In some embodiments, the image may be used to determine the position at which the storage box is to be placed after the storage box 2 has been picked up.

In some embodiments, the adjustment of the positions of the clamping units 110 may also be manually controlled, which may simplify the control of the clamping units.

Referring back to FIGS. 3A-3C, it is to be understood that in the case of non-symmetrical clamping of the side walls of the storage box, an unbalanced torque might arise, which may pose a significant problem especially when the storage box 2 is heavy.

In order to provide a stable clamping of the storage box 2, in some embodiments a balancing mechanism 16 may be provided on a respective joint portion between the respective adjacent sides of the frame 10, and configured to abut against a respective joint part between the respective adjacent side walls of the storage box 2 (especially a respective joint part between the respective adjacent opening-side edges). With such an arrangement, the balancing mechanism 16 may then produce a force to counteract the rotational torque resulting from the asymmetrical clamping of the side walls of the storage box.

For example, a balancing mechanism 16 may be provided on a joint portion between the first side 11 and the second side 12 of the frame 10, and configured to abut against a joint part between the first side wall 21 and the second side wall 22 of the storage box 2 (especially a joint part between the opening-side edge of the first side wall 21 and the opening-side edge of the second side wall 22). The balancing mechanism 16 may then produce a force to counteract the rotational torque resulting from the asymmetrical clamping of the first side wall 21 and the second side wall 22 of the storage box 2.

In some embodiments, the balancing mechanism 16 may be a column with a fixed length which may extend vertically with respect to the plane of frame 10 from the joint portion between the first side 11 and the second side 12 of the frame 10.

In some embodiments, the balancing mechanism 16 may be an extendable balancing mechanism, which may comprise an actuator (not shown) and an extendable end configured to be actuated by the actuator. Under the actuation of the actuator, the extendable end may be extended to abut against or retracted from the joint part between the first side wall 21 and the second side wall 22 of the storage box 2.

Typically, the actuator of the balancing mechanism 16 may be selected from a group consisted of a pneumatic actuator, a hydraulic actuator and an electric actuator. The actuator of the balancing mechanism 16 may also be controlled by the controller 15 as stated above. During the pick-and-placing operation of the storage box 2, the balancing mechanism 16 may be simultaneously controlled together with the plurality of clamping units 110, which may significantly improve the stability of the pick-and-placing operation.

Various embodiments of the robot-aided clamping device have been described in detailed. Those skilled in the art would appreciate that with the asymmetrical clamping of the side walls of the storage box 2, the robot-aided clamping device of the present disclosure may adapt to various stacking condition, which may significantly improve the working efficiency.

Other variations to the disclosed embodiments can also be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A robot-aided clamping device for pick-and-placing a storage box, comprising:
a frame configured to be mounted on an end effector of a robot; and
a plurality of clamping units including:
at least one first clamping unit mounted on a first side of the frame and configured to clamp a first side wall of the storage box; and
at least one second clamping unit mounted on a second side of the frame and configured to clamp a second side wall of the storage box;
wherein the first side and the second side are non-opposite sides of the frame, and the first side wall and the second side wall are non-opposite side walls of the storage box.

2. The robot-aided clamping device of claim 1, wherein the first side and the second side are asymmetrical or adjacent sides of the frame, and the first side wall and the second side wall are asymmetrical or adjacent side walls of the storage box.

3. The robot-aided clamping device of claim 1, wherein
each of the plurality of clamping units comprises:
an actuator; and
at least two clamping jaws configured to be actuated by the actuator to clamp the respective side wall of the storage box.

4. The robot-aided clamping device of claim 3, wherein the at least two clamping jaws comprise:
at least one inner jaw configured to abut against the inner surface of the respective side wall; and
at least one outer jaw configured to abut against the outer surface of the respective side wall, such that the respective side wall is clamped between the at least one inner jaw and the at least one outer jaw.

5. The robot-aided clamping device of claim 4, wherein the storage box has at least one protrusion rib or recess on its outer surface, the at least one outer jaw has a hook part configured to engage with the at least one protrusion rib.

6. The robot-aided clamping device of claim 1,
wherein the first side is a long side of the frame as compared to the second side, and the first side wall is a long side wall of the storage box as compared to the second side wall;
wherein the at least one first clamping unit comprises two first clamping units mounted on the first side of the frame, and the at least one second clamping unit comprises only one second clamping unit mounted on the second side of the frame.

7. The robot-aided clamping device of claim 1, wherein the at least one first clamping unit and the at least one second clamping unit each are configured to be movable along the respective side of the frame.

8. The robot-aided clamping device of claim 1, further comprising:
a balancing mechanism arranged on a joint portion between the first side and the second side of the frame, and configured to abut against a joint part between the first side wall and the second side wall of the storage box.

9. The robot-aided clamping device of claim 1, wherein the clamping unit is selected from a group consisted of a pneumatic clamping unit, a hydraulic clamping unit and an electric clamping unit.

10. The robot-aided clamping device of claim 9, wherein the pneumatic clamping unit comprises a pneumatic actuator and at least two clamping jaws comprising two parallel jaws configured to be moved in parallel with each other, or two angular jaws configured to be moved in an angular manner with respect to each other.

11. The robot-aided clamping device of claim 1, further comprising:
an image acquiring device configured to obtain the image of the storage box and/or at least one of the plurality of clamping units.

12. The robot-aided clamping device of claim 1, further comprising:
a controller configured to control the actuation of the plurality of clamping units and/or determine the position of at least one of the plurality of clamping units.

13. The robot-aided clamping device of claim 1, wherein the frame has a shape or a size corresponding to that of the storage box.

14. The robot-aided clamping device of claim 1, wherein the frame and the storage box both have a rectangular shape.

15. A robot system comprising:
a robot having an end effector; and
the robot-aided clamping device of claim 1 mounted on the end effector.
